(19) United States
(12) Patent Application Publication
(10) Pub. No.: US 2006/0136313 A1
(43) Pub. Date: Jun. 22, 2006

(54) Islamic finance

(76) Inventors: Keith Maxwell Driver, Sevenoaks (GB); Ruggiero Lomonaco, London (GB); Ali Abbas Zaidi, London (GB)

Correspondence Address: Stephen M. De Klerk;BLAKELY, SOKOLOFF, TAYLOR & ZAFMAN LLP, Seventh Floor, 12400 Wilshire Boulevard, Los Angeles, CA, 90025, US

(21) Appl. No.: 11/102,093

(22) Filed: Apr. 8, 2005

(30) Foreign Application Priority Data
Dec. 17, 2004 (GB) 0427633.3
Apr. 1, 2005 (GB) 0506686.5

(51) Int. Cl. G06Q 40/00

(52) U.S. Cl. 705/35; 705/38

(57) ABSTRACT

An Islamically-compliant method of transferring a financial, investment or pricing risk from a initial entity to an ultimate entity by means of an intermediate entity is disclosed. The first entity acquires a risk of financial, investment or pricing loss. The intermediate entity provides protection policy to the first entity against a predetermined protected risk, the protected risk being at least part of the risk of financial etc. loss. The first entity provides a protection premium to the intermediate entity for the protection, the premium being in the form of a charitable contribution, such that a profit is repaid to the first entity in the event that the protected risk does not come to pass. The ultimate entity may make an investment in the intermediate entity by providing funds or a contractual commitment such as a re-protection policy at least partially to cover the protected risk. The ultimate entity is thereby exposed at least partially to the protected risk.

### FIELD OF THE INVENTION

This invention relates to methods for enabling the management and transfer of financial risks in a way which is compliant with Islamic principles or Shariah.

### BACKGROUND

The Islamic financial services industry today stands at an estimated size of US$270 billion and consists of more than 200 financial institutions in and outside the Muslim world. When compared with Western financial services, the Islamic financial services industry is a young industry which continues to evolve and expand both in size and territory. The main growth has taken place in the last 20 years as a result of the oil boom of the 1980s.

Islamic financial services are traditionally indigenous and community-focused: catering to devout Muslims in indigenous Muslim societies; as well as Muslim minorities in non-Muslim countries. However they are inclusive in that they are also open to non-Muslim individuals and communities that seek ethical financial solutions. Ethical considerations are an important factor, Islamic finance aims to be an ethical and equitable mode of finance that derives its principles from the Shariah.

The most distinctive element of Islamic finance is the prohibition of any type of interest, whether “nominal” or “excessive,” simple or compound, fixed or floating. The principle is that money should not be earned by the lending of money to another. This means that as well as screening out undesirable companies based on their nature of business (e.g., alcohol, pork production etc.) Islamic investing also screens out companies on the basis of their level of involvement with interest.

Other elements of Islamic finance include the emphasis on equitable contracts, the linking of finance to productivity, the desirability of profit sharing and the prohibition of gambling and certain types of uncertainty. These parameters define the nature and scope of Islamic finance, as interpreted by the Shariah scholars that work with Islamic financial institutions.

A consequence of the principles set out above is that Islamic finance favours equity financing over debt financing. In other words financial transactions are based on assets instead of interest-bearing instruments. The classical equity instruments in Islamic commercial law (musharaka and mudaraba) require partnership and profit sharing, to which the contemporary devices of venture capital, investment management and project financing can be compared.

It also discourages speculation and precludes short selling, conventional debt instruments and derivatives. These views go back to the prohibition of interest, gambling and certain types of uncertainty in Islamic law.

In financial markets, investing in stocks and equity funds is permitted but must conform to certain guidelines.

Conventional debt financing (e.g., interest-based lending or conventional bonds) is prohibited due to the reliance on interest. Islamic asset-backed debt financing can be designed, however, on the basis of sale or leasing contracts that provide fixed income alternatives to conventional debt financing (e.g., murabaha and ijara). The capital provider must have ownership of the asset, even if briefly, and bear the risk associated with that ownership.

Islamic fixed income securities (Sukuks) can also be designed from such asset-backed debt financing.

The need to rely on asset-based transactions—for example the purchase and subsequent lease of an aircraft or ship—limit the potential for growth of Islamic financial services. The reason for this is that transactions are documentation-intensive. Locating assets and transferring their ownership is difficult and cumbersome. The investments consequently have limited liquidity as they cannot easily be traded.

### OBJECT OF THE INVENTION

It is an object of the present invention to expand the opportunities available to those who wish to invest without violating Islamic principles.

### SUMMARY OF THE INVENTION

The present invention provides a method of transferring a financial, investment or pricing risk from an initial entity to an ultimate entity by means of an intermediate entity, comprising;

said initial entity acquiring a risk of financial, investment or pricing loss;

said intermediate entity providing an insurance policy to said first entity against a predetermined insured risk, said insured risk being at least part of said risk of financial loss;
said first entity providing an insurance premium for said insurance to said intermediate entity, said premium being in the form of a charitable contribution, such that a profit is repaid to the first entity in the event that said insured risk does not come to pass; and

said ultimate entity making an investment in said intermediate entity by providing funds or a contractual committmentat least partially to cover said insured risk and thereby being exposed at least partially to said insured risk.

Thus it will be seen by those skilled in the art that in accordance with the invention the risk is transferred from the entity that initially acquires it to the ultimate entity via the intermediate entity by means of the insurance (protection) policy which can be arranged in compliance with Islamic law. Such an insurance/protection policy is known as Takaful. The Applicants have recognised that Takaful insurance/protection can be used in this way—it is not believed to have been used other than for small-scale personal and business insurance in the past.

The investment in the intermediate entity by the ultimate entity can give rise to an investment instrument which can be transferred and traded in a similar way to conventional Western securities, shares, bonds and the like. Importantly however the method set out in accordance with the invention enables the transfer of risk and subsequent trading without employing interest-bearing instruments; rather the risk is transferred away from the asset in return for insurance/protection policy premiums. This means that the transfer of risk may be effected in compliance with Islamic law. Generally the ultimate entity will be an arms-length investor with no direct connection to the first entity.

One way of looking at the invention is that it essentially combines elements of corporate and institutional banking; insurance/protection; and capital markets. Such a combination is strongly counter-intuitive, especially in the Islamic finance sphere, since these separate financial systems have tended to operate independently of one another and under differing rules and regulatory regimes.

The benefits of the invention are broadly applicable with regard to the types of risk which may be transferred from the first entity and subsequently traded. This reflects the Inventors' realisation that Islamically-compliant insurance/protection is not limited with respect to the types of risk which may be insured/protected. In one non-limiting set of embodiments a risk associated with a contract for goods or services could be transferred. For example the risk of default, of adverse currency movements or of unforeseen expenses arising could be transferred.

In a convenient set of embodiments the risk of financial loss is associated with the acquisition of one or more assets by the first entity. For example the first entity could purchase an asset and subsequently lease it but transfer the risk of default in the lease payments to another, ultimate entity via the intermediate entity. This may be contrasted with the previous situation under Islamic finance law whereby asset-based transactions (e.g. the purchase and subsequent leasing) are permitted, but no permissible mechanism existed whereby any of the risks associated with ownership or exploitation of the asset could be separated out. Furthermore there was no mechanism to protect against non-asset based risks such as currency risks.

The asset could be a physical asset such as an aircraft or ship; real estate or an intangible asset such as an equity stock in a company (provided that the company met the usual Islamic investment criteria referred to hereinabove and well known per se).

The initial transaction whereby the first entity acquires the risk must, in order for the overall method to be Islam-compliant, itself be Islam-compliant. In one set of possible implementations this initial transaction comprises a credit sale financing transaction or Murabaha. Typical applications of such transactions include: inventory financing for raw materials, components and spare parts etc.; bridge financing for purchasing of equipment, financing the purchase of shares; financing the purchase of property and financing commodity purchases such as oil, metal etc. However these are only examples and the possible applications extend beyond these. As will be known to those skilled in the art of Islamic finance, in one possible implementation of Murabaha the first entity purchases an asset from a supplier on behalf of a customer and the re-sells the asset to the customer (who may not be the supplier) on deferred terms so that ownership passes to the customer. In an alternative implementation the customer may purchase the asset on behalf of the first entity. However in all such arrangements the first entity acquires a risk such as the risk of the customer defaulting on payments. Previously the first entity had no option but to bear this risk, but now, in accordance with the invention the first entity may pass on the risk to another entity (the ultimate entity).

In another set of possible implementations the initial transaction comprises a lease financing transaction or Ijara. As will be known to those skilled in the art of Islamic finance, in one possible implementation of Ijara the first entity purchases an asset from a supplier and then leases the asset to a lessee in return for rental payments In this instance the lessee may also be the supplier. In other words the owner of an asset may sell it to the first entity (e.g. a bank) and then make rental payments to the for continued use of the asset. In accordance with Islamic principles the full ownership of the asset rests with the purchasing entity. Thus the purchasing entity is primarily responsible for major maintenance or repair. Clearly the possibility of costly repairs becoming necessary is a risk of financial loss. It is also entitled to rentals only when the asset is in use. It therefore acquires the risk of the asset being under-utilised. Also the owner cannot itself receive penalty compensation for late payments under Islamic principles. It therefore also acquires this risk. In the prior art the owner/lessor remained burdened with this risk, in the implementation of the invention set out however it may be transferred to the ultimate entity and subsequently traded.

The investment made by the ultimate entity in the intermediate entity could take a number of forms. The common factor is that the investor is exposed to at least some of the insured/protected risk. One suitable class of investment instruments comprises equities. Another suitable class of investment instruments comprises trust certificates or even trade shares issued by a suitable trust. More generally any security capable of complying with Islamic investment law could be employed. It should be appreciated that such equities, securities etc. are linked to the insured risk. This allows “line item” or specially-constructed portfolios to be segregated, packaged and traded, even in the event that the equity of the intermediate entity is the tradeable instrument.

The invention extends to such securities per se and thus when viewed from another aspect the invention provides an investment security issued by or on behalf of an entity authorised to issue Islamically-compliant insurance policies, said security being linked to a risk insured by an Islamically-compliant insurance policy.

It will be appreciated from the foregoing that the intermediate entity set out above is a key element of the present invention. Indeed the financial function it provides in accordance with the invention is novel and inventive in its own right. Thus when viewed from a further aspect the invention provides a financial institution having an insurance policy with first entity against a predetermined insured risk, said insured risk being at least part of a risk of financial loss to which said first entity is exposed, wherein said insurance policy requires an insurance premium payable to said financial institution, said premium being in the form of a charitable contribution, such that a profit is repaid to the first entity in the event that said insured risk does not come to pass in a predetermined time; said financial institution also having one or more investment instruments which allow an ultimate entity to invest in said financial institution by providing funds at least partially to cover said insured risk whilst being exposed to at least partially to said insured risk.

Where in accordance with the invention a risk is transferred from a first entity to an ultimate entity, this is done without relying on interest-based instruments in contrast with conventional financing arrangements. It is however preferred in accordance with the invention that the policy premium payable by the first entity is set to a level that gives a similar financial result to that which would have been achieved if the arrangement had been structured to include interest-based instruments. It is clearly beneficial for the economic viability of the invention that the results achieved are not at significant variance with more conventional financial products.

It should be appreciated that the term investment is to be construed broadly and is not limited to any particular type or class of financial instrument. For example exposure of the ultimate entity to the insured/protected risk may be by way of a re-insurance arrangement. Preferably such a re-insurance arrangement is itself Islamically compliant—i.e. re-Takaful.

When viewed from, a further aspect therefore the invention provides a method of transferring a financial, investment or pricing risk from an initial entity to an ultimate entity by means of an intermediate entity, comprising:

said first entity acquiring a risk of financial, investment or pricing loss;

said intermediate entity providing an insurance policy to said first entity against a predetermined insured risk, said insured risk being at least part of said risk of financial loss;

said first entity providing an insurance premium for said insurance to said intermediate entity, said premium being in the form of a charitable contribution such that a profit is repaid to the first entity in the event that said insured risk does not come to pass; and

said ultimate entity re-insuring said intermediate entity and thereby being exposed at least partially to said insured risk.

The first entity may conveniently be a bank but could equally be a special purpose vehicle (SPV) set up or used specifically for the transaction in question or indeed any commercial or legal entity or undertaking, including an individual. Indeed both the first and ultimate entities can in general be any financially capable entity including but not limited to corporations, associations, individuals, trusts, investment funds or even places of worship.

In preferred implementations the intermediate entity may be located in a different jurisdiction to the first entity.

### BRIEF DESCRIPTION OF DRAWINGS

Certain preferred implementations of the present invention will now be described, by way of example only, with reference to the accompanying drawings in which:

FIG. 1 is a schematic block diagram showing the basic operation of an intermediate entity in accordance with the invention; and

FIG. 2 is a block diagram showing a financing arrangement embodying the invention.

### DETAILED DESCRIPTION OF PREFERRED IMPLEMENTATIONS

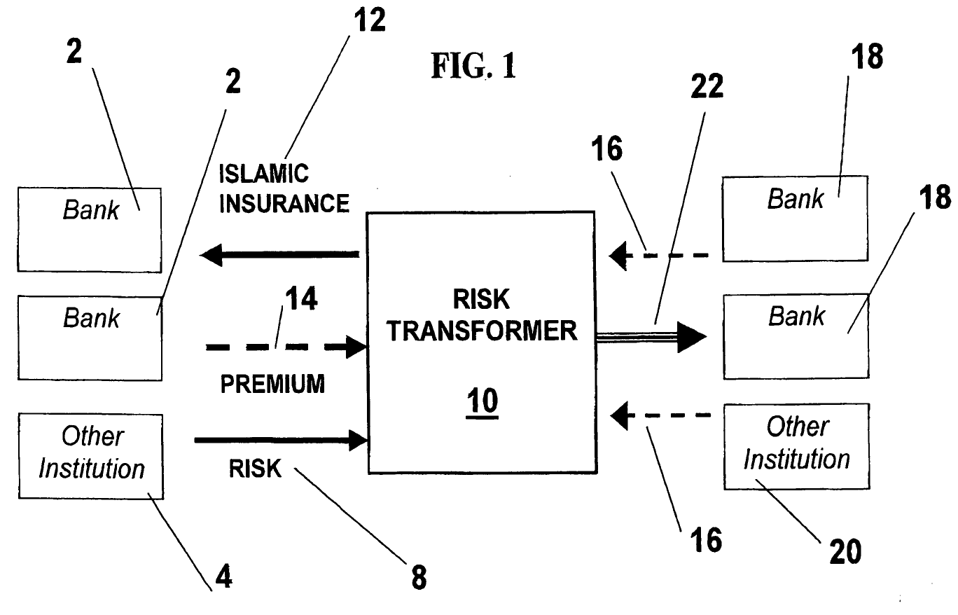

Turning firstly to FIG. 1 a schematic block diagram showing the basic operation of an implementation of the invention. On the left-hand side of the diagram may be seen a plurality of first entities including banks 2 and other institutions 4 exposed to a risk. The risk may be associated with an Islamically-compliant asset held by the entity 2,4 such as an aircraft, real estate etc. or it may be another such as a risk arising from changes in currency rates (so-called FX risk) or from changes in equity prices (so-called equity risk).

In accordance with the invention any or all of the aforementioned risks 8 may be transferred initially to an intermediate entity 10. The intermediate entity 10 comprises a financial institution authorised to offer Islamically-compliant Takaful insurance or protection policies. To effect the initial transfer of risk the intermediate entity 10 issues a Takaful protection policy 12 in return for an protection premium 14. The policy 12 sets out in detail the risks protected, the principal amount protected, the formula for calculating losses and the claim settlement process.

Being a Takaful policy the premium 14 is a charitable contribution—that is made to help others. The policy is written so that a profit share is repaid to the first entity 2,4 at the end of the contract period if the risk protected against did not actually come to pass and surplus finds exist. This gives the symmetry to the contract and reduces uncertainty, as required by Islamic law. The funds are segregated and treated as required by Islamic law, in a manner well known per se in the art.

Capital 16 is provided to the intermediate entity 10 by a plurality of ultimate entities in the form of investors which may be banks 18 or other institutions 20. Each investor 18,20 invests a fixed amount in return for a security 22 such as, for example equities or trust certificates. The capital 16 is managed and invested by the intermediate entity 10. The investment securities 22 are exposed to the business of the intermediate entity 10 and so the investors 18,20 will be exposed to the risks covered by the Takaful policies 12.

The investors 18,20 receive pre-agreed returns on pre-agreed dates. The returns are linked to the risk of the underlying Takaful policies 12 as they will generally comprise the premiums 14 received less the intermediate entity's charges for management and administration services provided—e.g. local regulatory filings.

If there is no claim under the policies 12 the principal capital is repaid to the investors. If there are any claims, these will be deducted from the capital before it is repaid.

The securities 22 do not have to be retained by the initial investors 18,20. They can be traded in the same way as other financial instruments. Indeed it is anticipated that whole new classes of investment securities will be created and an Islamic risk transfer securities or certificates market will be developed.

It will thus be seen that in accordance with the method set out above the risk acquired by the first entity may be effectively removed and transferred to third-party investors in the form of investment securities which may be traded in open markets, all in a way which is compliant with Islamic financial law. This opens up a wide range of possibilities for expanding Islamic financial markets and financial services.

In another set of embodiments the ultimate entity is exposed to the risk by a re-insurance arrangement. In this case the intermediate entity would pay a premium to the ultimate entity.

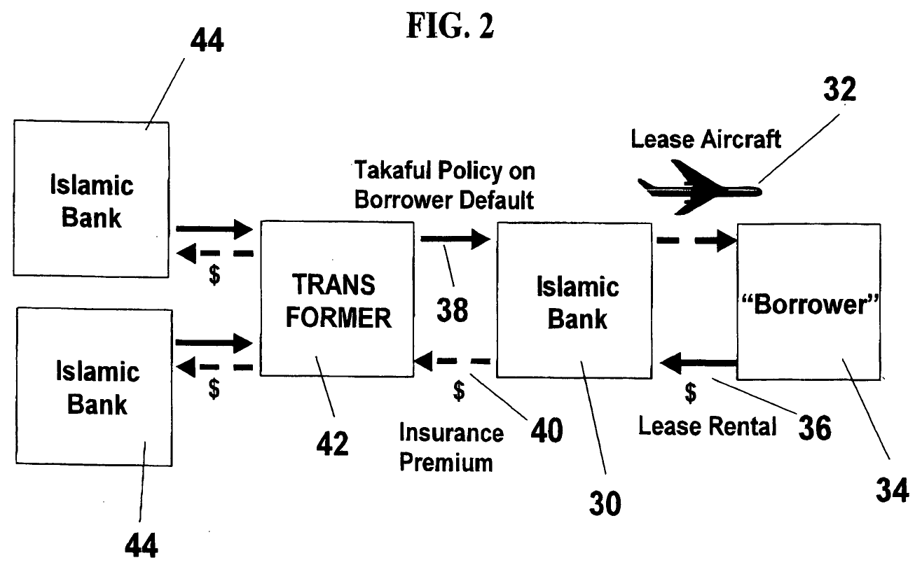

A more specific example of an implementation of the invention will now be given with reference to FIG. 2. In this example an Islamic bank 30 purchases an aircraft 32 on behalf of a “borrower” 34. The borrower does not, however, borrow any money. Rather it leases the aircraft 32 for a fixed period of time after which it acquires ownership. During the period of the lease it gives the bank 30 a rental income 36. The bank 36 is exposed to a risk of default in payment of the rental amounts by the “borrower” 34. However the bank 30 can protect against this risk through a Takaful protection policy 38 for which it pays a protection premium 40. The policy is with an intermediate entity 42 which passes on this risk to other Islamic institutions 44 which invest by buying securities issued by the intermediate entity. The institutions 44 thus participate in the original risk of default on the part of the “borrower” 34. The securities bought by the institutions 44 are transferable and tradeable.

It will be appreciated by those knowledgeable in the art that there are many variants and alternatives to the methods set out above within the spirit and scope of the invention as set out in the appended claims. For example a default risk is simply one of a large number of risks which may be protected in accordance with the invention. Other possibilities include currency rate risks, equity risks, weather risks, natural disaster risks, portfolio concentration risk, political, sovereign and regulatory risks and so on.

The first and ultimate entities can in general be any financially capable entity including but not limited to corporations, associations, individuals, trusts, investment funds or even places of worship.

What is claimed is:

1. A method of transferring a financial, investment or pricing risk from a initial entity to an ultimate entity by means of an intermediate entity, comprising:
said first entity acquiring a risk of financial, investment or pricing loss;
said intermediate entity providing an insurance policy to said first entity against a predetermined insured risk, said insured risk being at least part of said risk of financial loss;
said first entity providing an insurance premium for said insurance to said intermediate entity, said premium being in the form of a charitable contribution, such that a profit is repaid to the first entity in the event that said insured risk does not come to pass; and
said ultimate entity making an investment in said intermediate entity by providing funds or a contractual commitment at least partially to cover said insured risk and thereby being exposed at least partially to said insured risk.

2. A method as claimed in claim 1 which is compliant with Islamic law or principles.

3. A method as claimed in claim 1 wherein said insured risk arises from a contract for goods or services.

4. A method as claimed in claim 1 comprising said first entity purchasing an asset.

5. A method as claimed in claim 4 comprising said first entity leasing said asset to a lessee.

6. A method as claimed in claim 5 comprising said first entity entering into an Islamically-compliant lease financing transaction.

7. A method as claimed in claim 4 comprising said first entity selling said asset to a buyer in a deferred purchase agreement.

8. A method as claimed in claim 7 comprising said first entity entering into an Islamically-compliant credit sale financing transaction.

9. A method as claimed in claim 5 wherein said insured risk is a default risk.

10. A method as claimed in claim 7 wherein said insured risk is a default risk.

11. A method as claimed in claim 1 wherein said insured risk is a currency risk.

12. A method as claimed in claim 1 wherein said insured risk is a political or sovereign risk.

13. A method as claimed in claim 1 wherein the step of said ultimate entity investing in said intermediate entity comprises said ultimate entity purchasing a security issued by or on behalf of said intermediate entity.

14. A method as claimed in claim 13 wherein said security comprise an equity.

15. A method as claimed in claim 13 wherein said security comprise a trust certificate.

16. A method as claimed in claim 13 wherein said security is Islamically-compliant.

17. A financial institution having an insurance policy with first entity against a predetermined insured risk, said insured risk being at least part of a risk of financial loss to which said first entity is exposed, wherein said insurance policy requires an insurance premium payable to said financial institution, said premium being in the form of a charitable contribution, such that a profit is repaid to the first entity in the event that said insured risk does not come to pass in a predetermined time; said financial institution also having one or more investment instruments which allow an ultimate entity to invest in said financial institution by providing funds at least partially to cover said insured risk whilst being exposed to at least partially to said insured risk.

18. An Islamically-compliant investment security issued by or on behalf of an entity authorised to issue Islamically-compliant insurance policies, said security being linked to a risk insured by an Islamically-compliant insurance policy.

19. A method of transferring a financial, investment or pricing risk from a initial entity to an ultimate entity by means of an intermediate entity, comprising:
said initial entity acquiring a risk of financial, investment or pricing loss;
said intermediate entity providing an insurance policy to said first entity against a predetermined insured risk, said insured risk being at least part of said risk of financial loss;
said first entity providing an insurance premium for said insurance to said intermediate entity, said premium being in the form of a charitable contribution, such that a profit is repaid to the first entity in the event that said insured risk does not come to pass; and
said ultimate entity re-insuring said intermediate entity and thereby being exposed at least partially to said insured risk.
